(19) United States
(12) Patent Application Publication
(10) Pub. No.: US 2014/0197112 A1
(43) Pub. Date: Jul. 17, 2014

(54) POTABILISATION METHOD

(71) Applicant: Laura Crowther-Alwyn, Armentieres (FR)

(72) Inventor: Laura Crowther-Alwyn, Armentieres (FR)

(73) Assignee: ROQUETTE FRERES, Lestrem (FR)

(21) Appl. No.: 14/234,238

(22) PCT Filed: Jul. 19, 2012
(86) PCT No.: PCT/FR2012/051714

§ 371 Date: Feb. 24, 2014

(30) Foreign Application Priority Data
Jul. 22, 2011 (FR) 11 56702

(51) Int. Cl. C02F 1/52

(52) U.S. Cl. CPC C02F 1/5236; C02F 1/5272
USPC 210/729; 252/181

(57) ABSTRACT

A potabilisation method of a water to be treated, containing a coagulation-flocculation step wherein the step includes: a) a step of adding a liquid composition including a solubilized cationic starch to the aqueous solution to be treated; b) a step of adding one or several metal salts selected from ferric salts and aluminum salts to the aqueous solution to be treated; steps a) and b) being carried out in any order and being carried out either separately, simultaneously or using a liquid composition including both the solubilized cationic starch and the metal salt, the steps a) and b) being followed: c) by a step of stirring the supplemented aqueous solution; d) by a step of separating the coagulated solids by sedimentation or floatation; e) by a step of recovering a purified water; the liquid composition including cationic starch having a viscosity, measured according to test A, higher than 1000 mPa·s.

The invention relates to a method of potabilization of water, in particular a method comprising a coagulation-flocculation step using, together with a metal salt, a liquid composition of special solubilized cationic starch.

In the area of water, methods of treatment are very varied: for example, before being discharged into the environment, wastewaters or industrial process waters are not treated identically, depending on the nature of the water.

With regard to potable water, it is necessary to obtain a water of high purity at the end of the method. As water distribution is a crucial matter for human populations, more and more stringent controls have been imposed over the years. High purity of potable water is achieved by using very specific methods, quite different from the other methods of water treatment, where the water obtained may be of lower purity.

To obtain potable water, an aqueous solution can be pumped from underground water or from surface water that is to be treated, such as water from a lake or from a watercourse. This aqueous solution always comprises a variable amount of suspended particles, which must be removed.

For example, with regard to coarse particles, generally larger than 1 mm, they can be removed during a preliminary step by passing the aqueous solution through screens. This step is also called “screening step”.

Finer suspended particles can also be removed by separating them from the aqueous solution to be treated, for example by decanting or by flotation. Decanting consists of leaving the solution to stand in a settling tank, also called “sedimentation tank”, so that the suspended particles sink to the bottom of the tank. The purified water is thus recovered by decanting.

The principle of flotation is to mix the aqueous solution with air in flotation equipment, in order to recover the particles at the surface. The water thus treated is recovered at the bottom of the flotation equipment.

However, the aqueous solution generally comprises fine particles, which are particularly difficult to separate, especially colloidal particles of very small size, generally in the range from 1 nm to 1 μm.

For easier and quicker separation of these fine particles, a coagulation-flocculation step is carried out first. This step consists of agglomeration of the suspended particles: these coarser agglomerated particles are then separated more easily and more quickly by the separation treatments mentioned above.

For carrying out coagulation-flocculation, coagulants and flocculants are used, alone or mixed. These agents can be selected from the ferric salts or aluminum salts, anionic or cationic polyacrylamides and nonionic, anionic or cationic starches.

Generally, the coagulant and the flocculant are mixed in two separate steps with the aqueous solution to be treated in a tank, called coagulation-flocculation tank in the present application. This tank generally consists of a first basin called “coagulation basin” and a second basin called “flocculation basin”, into which the coagulant and the flocculant, respectively, are introduced. These phenomena of coagulation are generally explained by destabilization of the particles, in particular of the colloids, and of flocculation by the aggregation of these particles that are thus destabilized. Next, the aqueous solution comprising the agglomerates of particles or of colloids, called flocs, undergoes a separation step: purified water and sludges consisting of agglomerated flocs are thus recovered.

To measure the effectiveness of this coagulation-flocculation step, it is possible to measure the Chemical Oxygen Demand (COD) of the purified water, which is an indirect measure of the concentration of organic or mineral substances dissolved or suspended in said water: the amount of oxygen required for the complete chemical oxidation of these substances is measured. The amount of organic carbon dissolved in the treated water can also be measured.

Alternatively, it is also possible to measure the level of clouding of the aqueous solution, or turbidity, before and after this coagulation-flocculation step.

This turbidity is measured with a nephelometer (also called turbidimeter) and it is measured in Nephelometric Turbidity Units (NTU).

In this way, the decrease in turbidity is determined, which can be expressed as a percentage.

Another method is also to measure the absorbance of the aqueous solution treated at a given wavelength.

Moreover, in order to make a water potable, the water thus purified is generally subjected to a “filtration step” consisting of passing the water through one or more filters in order to remove certain residual contaminants. It is also possible to carry out a disinfection step, consisting of adding an agent or of using a treatment capable of eradicating the bacteria present in this water. These last-mentioned treatments are particularly useful in a method of potabilization.

The methods of water treatment are generally continuous processes.

In the case when a filtration step is carried out in order to make the water potable, the last particles remaining in suspension are removed from the aqueous solution by passing through filters. During this filtration, the particles therefore accumulate inside the filters and the latter become clogged. This results in a “loss of head”, i.e. a loss of flow of filtered water at constant pressure applied on the filter. So as not to have to increase the pressure to keep the flow constant and not to have to stop the process too frequently to change the clogged filter, the aqueous solution on which this filtration step is performed must have low turbidity, generally below 1.5 NTU, preferably below 1 NTU.

Similarly, for carrying out a disinfection step, it is advantageous to have water that is as clear as possible, in order to facilitate this disinfection step (decrease in the amount of agent required or lower intensity of the disinfection treatment).

Moreover, national regulations generally stipulate low turbidity for the distribution of potable water. For example, in France, this turbidity must be below 1 NTU.

Thus, the reduction in turbidity obtained during the coagulation-flocculation step is very important in a method of potabilization of water.

Methods of treatment of potable water using agents based on cationic starch have already been described. In fact, these cationic starches have the advantage of being manufactured from renewable vegetable resources and of being available in large volumes.

As an example of a method of potabilization, we may mention U.S. Pat. No. 5,543,056, which describes a method in which a coagulant, which can be cationic starch, and a flocculant, which is a clay, are added to the aqueous solution. This patent also describes, in the comparative tests, a method of potabilization using metal salts as coagulant in a first step, and a flocculant selected from chitosan or polyacrylamides in a second step.

It is also known for enzymatically or chemically liquefied cationic starches to be used simultaneously, in conjunction with an additional coagulant, in methods of treating wastewater that is discharged into the environment or recycled to an industrial plant; for treating an aqueous solution that is of very low viscosity, it is known to use a cationic starch that is also of low viscosity, so that it can act effectively with the additional coagulant.

As a document describing a method using such starches, we may mention document WO 200196403 A1. This describes, for the treatment of industrial process waters, the use of a cationic starch in association with a flocculant of the cationic polyacrylamide type. In particular, the effectiveness of a coagulation-flocculation step using a mixture of cationic polyacrylamide and cationic starch is investigated in example 10. The tests in that example show that, in combination with a cationic polyacrylamide, a cationic starch that has been liquefied and is therefore of low viscosity displays greater efficacy than a cationic starch that has not been liquefied.

There is at present still a need for new methods for potabilization of water.

In particular, it is advantageous if this method can be carried out in a very short treatment time, using a small amount of chemicals, and without modifying the installations used conventionally for these treatments. It must be able to give a considerable reduction in turbidity of the water treated.

It is this that the applicant has achieved by conducting studies into methods of potabilization of water.

In fact, the applicant found that a liquid composition of cationic starch having specific characteristics made it possible, when used in a coagulation-flocculation step jointly with a ferric salt and/or an aluminum salt, to effect a particularly substantial reduction in turbidity of the aqueous solution to be treated in comparison with the cationic starches used traditionally in this field. At the time of its introduction into the water to be treated, this particular starch must be in solubilized form in a liquid composition. This composition can be used, with a metal salt, in any type of method of obtaining a potable water comprising a coagulation-flocculation step.

In particular, the invention relates to a method of potabilization of an aqueous solution having solids in suspension, containing a coagulation-flocculation step, characterized in that said step comprises:

a) a step of adding a liquid composition comprising a solubilized cationic starch to the aqueous solution to be treated;

b) a step of adding one or more metal salts selected from ferric salts and aluminum salts to the aqueous solution to be treated;

steps a) and b) being carried out in any order and they can be effected separately, simultaneously or by means of a liquid composition comprising both the solubilized cationic starch and the metal salt, said steps a) and

b) being followed by:

c) a step of stirring the aqueous solution containing these additives;

d) a step of separating the coagulated solids by decanting or flotation;

e) a step of recovering purified water;

said liquid composition comprising cationic starch having a viscosity, measured according to a test A, above 1000 mPa·s, this test A consisting of adjusting the dry matter of the liquid composition to 10% and then measuring the Brookfield viscosity of the resultant composition at 25° C.

Test A, used for measuring the viscosity of said liquid composition, is applicable regardless of the form of presentation of the latter, liquid or pasty.

It consists of quantifying, by any conventional method within the capability of a person skilled in the art, the dry matter of said composition and, as appropriate, diluting it with distilled water or concentrating it by any suitable means that will not significantly alter the cationic amylaceous matter that it contains, and so as to adjust the dry matter of said composition to a value of 10%. Following this, the Brookfield viscosity of the resultant composition at 25° C. is measured in a manner that is known per se. To concentrate the composition without altering the amylaceous matter containing it, it is possible for example to use a rotary evaporator.

Unless stated explicitly, it should be noted that the amounts of cationic starch and metal salt are expressed as dry mass in the rest of the application.

The applicant found, surprisingly, that when it is used in a coagulation-flocculation step in association with a metal salt, a liquid composition having a high viscosity, i.e. above 1000 mPa·s, for a concentration of cationic starch referred to 10% of the total weight of the composition, made it possible to obtain an exceptional reduction in the turbidity of a solution that has solids in suspension. This is in contradiction to what is known for mixtures of cationic starch with an additional coagulant used for treating wastewater, for example as described in document WO 200196403 A1 in example 10 which teaches using, jointly with a cationic polyacrylamide, a liquefied composition of cationic starch, said solution having a Brookfield viscosity according to test A well below 1000 mPa·s. In fact, this liquid cationic amylaceous composition has a Brookfield viscosity below 1600 mPa·s when its dry mass is adjusted to 20%. The applicant found that this viscosity of 1600 mPa·s corresponds to a Brookfield viscosity below 200 mPa·s according to test A.

According to the method of the invention, the order of steps a) and b) is unimportant.

Advantageously, the time delay between steps a) and b) is less than 120 seconds, for example less than 90 seconds, advantageously less than 60 seconds. Preferably, steps a) and b) are carried out simultaneously. According to an advantageous embodiment of the invention, these two steps are carried out simultaneously by adding a liquid composition comprising both the cationic starch and the metal salt, making it possible to simplify the method.

The cationic starch can be obtained from pea starch, wheat starch, corn starch or a potato starch.

Preferably, the metal salt is a sulfate, a polysulfate, a chloride, a polychloride or a polychlorosulfate. Preferably, the metal salt is selected from aluminum polychloride and ferric chloride.

It can be added in step b) in the form of a liquid solution, having for example a concentration in the range from 0.01 to 60 g/l.

When several metal salts are added in step b), it should be noted that the amounts of metal salt are the total amounts of these various metal salts.

The method of the invention can be carried out with a total amount of cationic starch and of metal salt in the aqueous solution in the range from 4 to 500 ppm. This amount is adapted to the initial turbidity of the water and it can advantageously be from 5 to 20 ppm, preferably from 5 to 10 ppm.

It is particularly advantageous to carry out the method with these small amounts of coagulant; this makes it possible to limit, on the one hand, the cost of the process and, on the other hand, the amounts of sludges consisting of the coagulated suspended matter to be disposed of. Moreover, by selecting these amounts of coagulant, the metal salt remaining soluble in the water recovered in step e) remains slight.

According to a first variant of the method of the invention, the cationic starch/metal salt weight ratio can range from 15/85 to 70/30, for example from 15/85 to 60/40, advantageously from 15/85 to 55/45, preferably from 20/80 to 45/55.

According to a second variant, the cationic starch/metal salt weight ratio can range from 30/70 to 60/40. The applicant has found that the coagulation-flocculation step is particularly effective when these coagulants are introduced in the above ratios.

The cationic starch can have a degree of cationic substitution greater than or equal to 0.03, advantageously in the range from 0.035 to 0.2.

The liquid composition of cationic starch added in step a) advantageously has a concentration of cationic starch in the range from 0.01 to 50 g/L. The liquid of the composition can be any solvent of cationic starch and is preferably water.

The stirring step c) can be carried out in the presence of an additional treatment agent, which can be selected from algae, activated charcoals and potassium permanganate. The treatment agent is preferably activated charcoal or potassium permanganate.

The duration of the stirring step c) can be greater than or equal to 1.5 minutes or more, preferably in the range from 2 to 30 minutes, quite preferably in the range from 2.5 to 5 minutes.

The separation step d) can be a decanting step. This decanting step preferably has a duration in the range from 0.25 to 1000 minutes, preferably from 0.33 to 120 minutes, quite preferably from 0.5 to 12 minutes, for example from 1 to 5 minutes.

For further acceleration of the coagulation-flocculation step, the flocs can be ballasted, for example using microsand.

Another advantage of the invention is therefore that the coagulation-flocculation step can thus be carried out in a very short time.

According to the invention, the method can be continuous or discontinuous. In the case when it is a continuous method, the durations of steps c) and d) are thus respectively the average residence time of the aqueous solution to be treated in the coagulation-flocculation tank and in the sedimentation tank.

The method of potabilization according to the invention is particularly appropriate when it comprises, after the coagulation-flocculation step, a step of filtration of the purified water.

The aqueous solution comprising suspended solids to be treated can have a turbidity less than or equal to 1000 NTU, advantageously in the range from 2 to 300 NTU, preferably in the range from 2.5 to 150 NTU, for example in the range from 3 to 100 NTU. This aqueous solution can be a surface water, for example water from a lake or watercourse, or underground water.

The method is very suitable for removing suspended particles in the aqueous solution having a size in the range from 0.001 to 500 μm, in particular those in the range from 0.001 to 1 μm.

The turbidity of the purified aqueous solution thus obtained at the end of step e) is of low turbidity, for example less than or equal to 1.5 NTU, preferably below 1 NTU.

According to the method of the invention, the reduction in turbidity can be above 98%, advantageously above 98.5%, quite preferably above 99%. The method according to the invention makes it possible to greatly reduce the turbidity, which is very advantageous in a method of potabilization.

It should be noted that the reduction in turbidity depends on the initial turbidity: when using the method for water of low turbidity, the reduction will not be as great as for water having a higher turbidity.

The turbidity can be measured using a WTW Turb 555IR apparatus sold by the company WTW.

The liquid composition for use in the invention has a viscosity above 1000 mPa·s according to test A described above. As will be explained below, this particular viscosity is directly related to the cationic starch used and to the method of preparing the composition.

With regard to the cationic starch, the viscosity of the composition comprising it after solubilization depends on 3 main characteristics, in decreasing order of importance: its molecular weight, its degree of branching and its degree of cationicity. These characteristics are easily selected by a person skilled in the art by choosing the botanical source of the native starch and the conditions of preparation of this cationic starch.

The cationic starch used in the context of the invention can be obtained from any type of native starch of natural or hybrid origin, including starch obtained from vegetable organisms that have undergone mutations or genetic manipulations. Said starches can notably be obtained from potato, from potato with high amylopectin content (waxy potato), from wheat, from wheat with high amylopectin content (waxy wheat), from corn, from corn with high amylopectin content (waxy corn), from corn with high amylose content, from rice, from pea, from barley or from cassaya, cuts or fractions that can be produced from them, and any mixtures of at least any two of the aforementioned products.

Selection of this native starch has for example an influence on the final molecular weight as well as on its degree of branching, related to the content of amylose and of amylopectin.

The reaction of cationization can be carried out according to one of the methods well known by a person skilled in the art, using cationic reagents such as described for example in “Starch Chemistry and Technology”—Vol. II—Chapter XVI—R. L. WHISTLER and E. F. PASCHALL—Academic Press (1967). The starch is fed into a reactor in the presence of these reagents. Preferably, the starch used in the cationization reaction is in a granular form.

The reaction can be carried out in a milk phase, the granular starch suspended in a solvent being cationized using the conditions of temperature, of time and of catalysis well known by a person skilled in the art.

At the end of the reaction, the starch thus cationized can be recovered by filtration, and this cationic starch can then be washed and then dried.

Alternatively, the reaction can be carried out in the dry phase, i.e. in the presence of amounts of water added to the starch that are regarded as small, for example in amounts of water less than 20% of the mass of starch introduced for the cationization reaction, preferably less than 10%.

Preferably, the cationization reaction is carried out with nitrogen-containing reagents based on tertiary amines or quaternary ammonium salts. Among these reagents, it is preferred to use the 2-dialkylaminochloroethane hydrochlorides such as 2-diethylaminochloroethane hydrochloride or the glycidyl-trimethylammonium halides and their halohydrins, such as N-(3-chloro-2-hydroxypropyl)-trimethylammonium chloride, this last-mentioned reagent being preferred. This reaction is conducted in an alkaline medium, at a pH above 8, or even 10, and the pH can be adjusted for example with soda.

The reagent levels employed are selected in such a way that the resultant cationic starches have the desired degree of substitution (DS) of cationicity, DS being the average number of OH groups comprised on the anhydroglucose of the starch that have been substituted with a cationic group.

A person skilled in the art will know how to adjust the reaction conditions in order to obtain cationic starches allowing the liquid composition that is useful in the invention to be obtained. In fact, the starch must not be degraded to any great extent during the cationization process, i.e. its molecular weight is not substantially reduced, so that the composition useful in the invention has the appropriate viscosity.

In particular, to obtain the composition of cationic starch useful in the invention, it is generally necessary that the starch does not undergo a liquefaction treatment.

The cationic starch can be water-soluble at room temperature. Soluble at room temperature means according to the invention that when the cationic starch is introduced at 10 wt % of water at 20° C. and is stirred for 1 hour, the starch solution thus obtained has a Brookfield viscosity above 1000 mPa·s.

According to a first variant, the starch that is water-soluble at room temperature is a cationic granular starch having a degree of substitution (DS) greater than or equal to 0.10. According to a second variant, it is a pregelatinized cationic starch. This pregelatinization treatment of cationic starch can be carried out in a drum dryer.

To prepare the composition that is useful in the invention, the cationic starch must be solubilized in the solvent. The liquid composition is generally an aqueous composition, which can comprise mainly water and optionally small amounts of water-miscible organic solvents, such as alcohols such as methanol and ethanol, for example in amounts of organic solvent less than 10 wt % of the total amount of solvents.

To make the liquid composition that is useful in the invention, the cationic starch can be made soluble in the solvent by a cooking step. This cooking in water is generally carried out by suspending the cationic starch and thus forming a starch milk. To avoid thermally degrading the cationic starch during the cooking of this milk and thus obtain an aqueous composition satisfying the viscosity conditions useful in the invention, “mild” cooking of the starch milk is carried out. Mild cooking means cooking using a temperature that is not very high and/or a short duration, and a person skilled in the art will adapt the temperature and duration to obtain the viscosity useful for making the solution. The cooking temperature is for example in the temperature range from 40 to 95° C., advantageously from 60 to 90° C. The cooking time can range from 5 minutes to 60 minutes. The amount by weight of cationic starch in this milk can be between 10 and 30%, for example between 20 and 30%.

According to one variant, said composition is prepared using a cationic starch that is soluble at room temperature and dissolving it in water, preferably with stirring. This variant is advantageous as the starch can thus easily be solubilized in the liquid composition, without cooking. The composition useful in the invention can thus easily be used at the site carrying out the method of treatment. Moreover, as the cationic starch is not cooked during preparation of the composition, the starch is not degraded thermally during solubilization, making it possible to obtain a composition of higher viscosity than that obtained from one and the same starch that has undergone a step of cooking in the solvent.

As described above, a liquid composition can be used for carrying out the method according to the invention. This composition comprises a solubilized cationic starch and one or more metal salts selected from ferric salts and aluminum salts, and its viscosity, measured according to test A, is above 1000 mPa·s.

The viscosity of the liquid composition comprising the cationic starch, measured according to test A, is preferably between 10000 and 100000 mPa·s.

Preferably, the metal salt is an aluminum salt.

The composition advantageously has a cationic starch/metal salt weight ratio in the range from 15/85 to 70/30, preferably from 25/75 to 45/55.

Preferably, the pH of the composition according to the invention is between 3 and 7.

According to an advantageous variant of the invention, a liquid composition of preservative-free cationic starch is used.

When the cationic starch is in liquid form, degradation may be observed during its storage and transport of the product. To limit this phenomenon, it is generally necessary to add a biocide, which can be selected from the phthalates, for example one of those marketed by Rohm & Haas with the trademark VINYZENE™. Now, although the concentration of biocide necessary for the preservation of starch in the form of liquid solution is low, these biocides can constitute undesirable constituents for treatment of water and quite particularly for obtaining a potable water.

The fact that the starch is stored and transported in solid form limits the problems of degradation. This makes it unnecessary to add a preservative, which can be particularly advantageous in a method of water treatment.

Thus, according to a variant of the method, a solution of preservative-free cationic starch is prepared in a time of less than twenty-four hours before the addition step a) from a cationic starch in solid form, for example in the form of a powder.

The composition useful in the invention has a Brookfield viscosity above 1000 mPa·s in the conditions of test A. Measurement of this viscosity, using a viscosimeter of the Brookfield® make, is well known by a person skilled in the art. In particular, there are various modules for measuring this viscosity and each module is suitable for a given range of viscosity. All that is required is to select the module that is appropriate to the viscosity of the composition to be measured. As an example, test A can be performed using module RV2 at 20 revolutions per minute for a viscosity above 1000 mPa·s and less than or equal to 2000 mPa·s, module RV5 at 20 revolutions per minute for a viscosity above 2000 mPa·s and less than or equal to 20000 mPa·s, module RV7 at 20 revolutions per minute for a viscosity above 20000 mPa·s and less than or equal to 200000 mPas·s and module RV7 at 2 revolutions per minute for a viscosity above 200000 mPa·s.

The composition comprising the cationic starch can further comprise additional constituents, such as metal salts or the biocides already described. Thus, the dry matter of the composition useful in the invention can be constituted exclusively or almost exclusively of at least one cationic starch but can also contain one or more other components such as, for example, a biocide or other substances such as a metal salt described above.

The metal salt is advantageously aluminum polychloride or ferric chloride. In the case of ferric chloride, the cationic starch/metal salt ratio is preferably from 25/75 to 50/50, or even from 30/70 to 40/60. In the case of aluminum polychloride, the cationic starch/metal salt ratio is preferably from 20/80 to 45/55, or even from 25/75 to 35/65.

Although other coagulants can be used in the method, the latter can be carried out without other additional coagulant, in particular without polyacrylamide and without clay.

The coagulation-flocculation step can be carried out conventionally.

During the first steps a) to c) of the coagulation-flocculation step, the particles are coagulated, and then form flocs in a coagulation-flocculation tank.

This tank can comprise a first basin called “coagulation basin” and a second basin called “flocculation basin”, with a higher stirring speed in the first than in the second. Advantageously, the starch composition and the metal salt are put in the coagulation basin.

In the case of a continuous process, the aqueous solution to be treated is fed into said tank by means of a pump, thus making it possible to control the feed rate. The duration of the coagulation-flocculation step then depends on this feed rate and the volume of the tanks used. The salt and the starch for use in the invention can be mixed with the aqueous solution to be treated either before introducing this solution into the coagulation-flocculation tank, or directly in the tank via a second inlet provided for this purpose. The duration of this coagulation-flocculation step is directly dependent on the volume of the tank and on the feed rate selected.

The water to be treated can optionally undergo a pretreatment for adjusting its pH. Preferably, the pH of the aqueous solution comprising suspended solids ranges from 6 to 8.5.

For removing the flocs so as to be able to recover the purified water and carry out separation step d), either a decanting technique or a flotation technique can be selected. These techniques, which are well known by a person skilled in the art, can be carried out in standard installations for water treatment.

Preferably, sedimentation of the flocs formed is carried out in step d).

When this separation step is carried out by decanting, an agent for ballasting the flocs formed, such as microsand, can also be introduced into the coagulation-flocculation tank. These ballasted flocs are transferred with the aqueous solution to the sedimentation tank, making it possible to improve the rate of separation in the subsequent decanting step. The sedimentation tank can be a static sedimentation tank or a lamellar sedimentation tank. The sedimentation tank can be equipped with a bottom scraper for better capture of the sedimented sludge. The static sedimentation tank is the more traditional sedimentation tank: it consists of a simple tank in which the coagulated particles settle to the bottom of the tank, forming sludge, and the purified water after sedimentation is recovered by decanting.

Lamellar sedimentation tanks also allow the settling of the coagulated particles to be accelerated in comparison with static sedimentation tanks.

At the end of the coagulation-flocculation step, advantageously a further purification step can be carried out.

This can be, for example, a filtration step. As already explained, the coagulation-flocculation step used in the method according to the invention is then particularly advantageous.

This step of filtration of the water can be a step of microfiltration, of ultrafiltration or of nanofiltration. The filters used for this are filters comprising sand, anthracite or even activated charcoals. It is also possible to use membranes of organic polymers, notably of polypropylene, of polyacrylamide or of polysulfone. Filtration of the water can also be carried out by reverse osmosis using a semipermeable membrane in order to remove the solutes from it.

A step of disinfection of the water can also be carried out. Numerous techniques exist for disinfection of liquids. It can be carried out using ozone, by treatment with ultraviolet radiation or else using chlorine dioxide.

At the end of the process, a potable water is obtained, the turbidity of which is advantageously below 1 NTU.

Embodiments will now be presented in detail in the examples given below. It should be pointed out that these illustrative examples do not in any way limit the scope of the present invention.

### EXAMPLE 1

### Comparison of Different Coagulants for Reducing the Turbidity of a River Water, from the River Lys

Products Used:

APC: aluminum polychloride in solution.

FeCl₃: ferric chloride in solution.

PAM: emulsion of cationic polyacrylamide Flopam® DW 2160.

“A”: Solution of cationic starch with Brookfield viscosity, according to test A, of 11000 mPa·s. This solution “A” is obtained from a cationic starch (potato-based) comprising 1.2% of nitrogen (expressed in dry/dry weight). This starch is water-soluble at 20° C. The solution is prepared at 1% of starch with stirring at room temperature for one hour.

Protocol:

Several systems are evaluated by a jar test for potabilization of water taken from the Lys. The water is loaded with calcium carbonate (Mickart 5, average diameter 5 μm) until a turbidity of 100NTU is reached. 5 grams of microsand (diameter<100 μm) is added to 1 L of water with stirring, then the coagulant (or, simultaneously, the coagulants) is added, with stirring at 200 rpm for 3 minutes. The stirring is then stopped and the turbidity of the supernatant is measured after 3 minutes of sedimentation. The dose of coagulant used is stated in milligram of active substance per liter of water to be treated (mg/L).

The results obtained are reported in Table 1.

TABLE 1

| | | |
|---|---|---|
| | Turbidity of | |
| | the | Reduction |
| Coagulant (mg/L) | supernatant | in |

| FeCl₃ | APC | A | PAM | (NTU) | turbidity, % |
|---|---|---|---|---|---|
| 10 | — | — | — | 34 | 66 |
| 6 | — | 4 | — | <1 | >99 |
| — | — | 10 | — | 10 | 90 |
| — | 10 | — | — | 55 | 65 |
| — | 6 | 4 | — | <1 | >99 |
| — | — | — | 10 | 33 | 66 |
| 6 | — | — | 4 | 2 | 98 |
| — | 6 | — | 4 | 2 | 98 |

The solution of cationic starch is the best coagulant at a dose of 10 mg/L. In conjunction with a salt such as ferric chloride or aluminum polychloride, the turbidity is below 1 NTU, or a reduction of more than 99%.

### EXAMPLE 2

### Influence of Sedimentation Time on Turbidity

The water from the Lys (initial turbidity: 3 NTU) is tested in a jar test, either with a solution of aluminum polychlorosulfate of Aqualenc® type, or with a solution of salt and solution A with a metal salt:cationic starch weight ratio equal to 3:2. The total dose of salt used alone, or of salt and starch used together, is fixed at 10 mg per liter of water from the Lys. The coagulation-flocculation step is carried out in the same way as in example 1, except that the test is performed in the absence of sand. The turbidity is measured at different sedimentation times and the results obtained are presented in Table 2.

TABLE 2

Turbidity of the
supernatant (NTU)

| Sedimentation | | Salt/starch solution |
|---|---|---|
| time (min) | salt | mixture |
| 3 | 2.3 | 0.6 |
| 5 | 2.4 | 0.6 |
| 10 | 1.6 | 0.5 |
| 20 | 1.0 | 0.3 |
| 30 | 0.5 | 0.3 |

In the absence of sand, the water treated jointly with salt and starch reaches a turbidity below 1NTU after less than 3 minutes of sedimentation, versus 20 to 30 minutes with the salt used alone.

### EXAMPLE 3

### Effect of the Cationicity and the Viscosity of the Starch on the Turbidity of the Treated Water

Starch Solutions Used

“B”: Solution of cationic starch with Brookfield viscosity, according to test A, of 22000 mPa·s. This solution “B” is obtained from a pregelatinized cationic starch (potato-based) comprising 0.4% of nitrogen (expressed in dry/dry weight). This starch is water-soluble at 20° C. The solution is prepared at 1% of starch with stirring at room temperature for one hour.

“C”: Solution of cationic starch with Brookfield viscosity, according to test A, of 86000 mPa·s. This solution “C” is obtained from a cationic starch (potato-based) comprising 0.3% of nitrogen (expressed in dry/dry weight). The solution is prepared by cooking a solution at 95° C. for 15 minutes.

“1” (comparative): Solution of cationic starch with Brookfield viscosity, according to test A, of 2 mPa·s. This solution “1” is obtained from a cationic starch (potato-based) comprising 0.3% of nitrogen (expressed in dry/dry weight). The solution is prepared with stirring at room temperature for one hour.

“2” (comparative): Solution of cationic starch with Brookfield viscosity, according to test A, of 600 mPa·s. This solution “2” is obtained from a cationic starch (potato-based), which has undergone a liquefaction treatment, comprising 1.2% of nitrogen (expressed in dry/dry weight). The solution is prepared at 1% of starch.

“3” (comparative): Solution of potato starch, nonionic, with Brookfield viscosity, according to test A, of 200000 mPa·s. The solution is prepared by cooking the starch in water at 95° C. for 15 minutes.

The various starch solutions are tested alone or jointly with a solution of ferric chloride, with a salt:starch weight ratio equal to 3:2. The total dose of starch used alone, or of salt and starch used together, is fixed at 10 mg per liter of water from the Lys. The test protocol is the same as in example 1 and the results obtained are presented in Table 3.

TABLE 3

| | | | | Used together | |
|---|---|---|---|---|---|
| | Viscosity | Used alone | | with FeCl₃ | |
| | of the | Turbidity of | Reduction | Turbidity of | Reduction |
| | starch | the | in | the | in |
| | in water | supernatant | turbidity, | supernatant | turbidity, |
| Starch | at 10% | (NTU) | % | (NTU) | % |
| A | 11 000 | 13 | 87 | <1 | >99 |
| B | 22 000 | 11 | 89 | <1 | >99 |
| C | 86 000 | 13 | 87 | <1 | >99 |
| 1 | 600 | 20 | 80 | 5 | 95 |
| 2 | 2 | 50 | 50 | 50 | 77 |
| 3 | 200 000 | 21 | 79 | 2 | 98 |

Used alone, none of these starch solutions makes it possible to reduce more than 90% of the turbidity. In contrast, mixed with a solution of ferric chloride, the solutions according to the invention (A, B and C) make it possible to achieve reductions in turbidity of more than 99%.

### EXAMPLE 4

### Determination of the Optimal Dosage of Coagulant Based on Cationic Starch and Metal Salt

Ferric chloride and starch solution A (salt:starch ratio of 3:2) are tested jointly in a jar test at different doses according to the test protocol in example 1.

The results obtained are presented in Table 4.

TABLE 4

| Dose of | Turbidity of the | |
|---|---|---|
| coagulant | supernatant | Reduction in |
| (mg/L) | (NTU) | turbidity, % |
| 0 | 100 | 0 |
| 4 | 1.5 | >98 |
| 6 | 0.9 | >99 |
| 8 | 0.6 | >99 |
| 10 | 0.5 | >99 |
| 20 | 0.6 | >99 |

On this water, the mixture is therefore effective starting from 6 mg/L, and exceeds 99% reduction in turbidity.

### EXAMPLE 5

### Determination of the Optimal Cationic Starch:Metal Salt Ratio

Ferric chloride and starch solution A from example 1 are tested together in a jar test using various cationic starch/ferric chloride weight ratios, for a total dosage of 10 mg/L. The test protocol is the same as in example 1.

Here, the absorbance of the unfiltered supernatant at 254 nm is also measured.

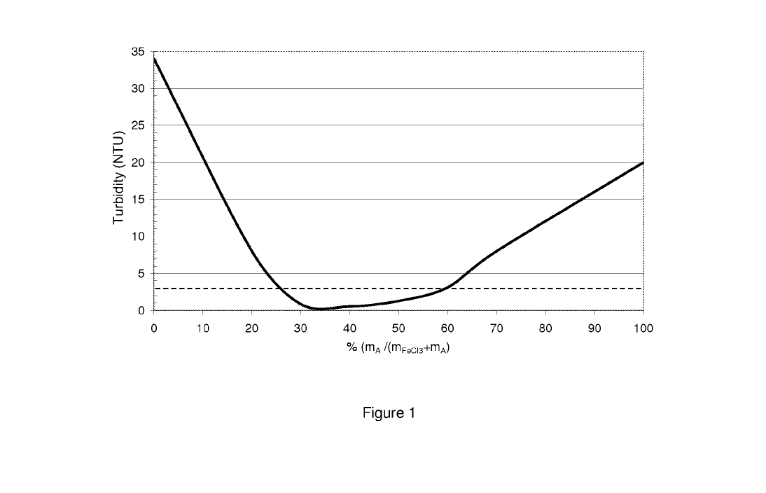

The results are reported in Table 5. FIG. 1 also shows the evolution in turbidity as a function of the amount of starch by weight relative to the total amount of starch and of metal salt.

TABLE 5

| Starch/ | Turbidity | Reduction in | |
|---|---|---|---|
| FeCl₃ ratio | (NTU) | turbidity, % | Absorbance |
| 0/100 | 34 | 66 | 0.174 |
| 20/80 | 8 | 92 | 0.086 |
| 30/70 | 0.9 | >99 | 0.074 |
| 40/60 | 0.5 | >99 | 0.078 |
| 50/50 | 1.3 | >98 | 0.088 |
| 60/40 | 3 | 97 | 0.112 |
| 70/30 | 8 | 92 | 0.140 |
| 100/0 | 20 | 80 | 0.103 |

APC1 is an aluminum polychlorosulfate in solution. It is mixed with cationic starch A. The tests in a jar test are carried out at different cationic starch/aluminum salt ratios, for a total dosage of 10 mg/L. The test protocol is the same as in example 1. The results are reported in Table 6.

TABLE 6

| Starch/ | | | |
|---|---|---|---|
| APC1 | | | |
| weight | Turbidity | Reduction in | |
| ratio | (NTU) | turbidity, % | Absorbance |
| 14/86 | 9.0 | 91 | 0.059 |
| 20/80 | 3.1 | 97 | 0.053 |
| 28/72 | <1 | >99 | 0.050 |
| 40/60 | <1 | >99 | 0.060 |
| 60/40 | 1.5 | >98 | 0.062 |

APC2 is an aluminum polychloride in solution. It is mixed with cationic starch A. The tests in a jar test are carried out at different cationic starch/aluminum salt ratios, for a total dosage of 10 mg/L. The test protocol is the same as in example 1. The results are reported in Table 7.

TABLE 7

| Starch/ | | | |
|---|---|---|---|
| APC2 | | | |
| weight | Turbidity | Reduction in | |
| ratio | (NTU) | turbidity, % | Absorbance |
| 16/84 | 35 | 65 | 0.113 |
| 22/78 | 24 | 76 | 0.089 |
| 29/71 | 5 | 95 | 0.058 |
| 39/61 | <1 | >99 | 0.051 |
| 53/47 | 1 | 99 | 0.057 |
| 71/29 | 6 | 94 | 0.088 |

APC3 is an aluminum sulfate in solution. It is mixed with cationic starch A. The tests in a jar test are carried out at different cationic starch/aluminum salt ratios, for a total dosage of 10 mg/L. The test protocol is the same as in example 1. The results are reported in Table 8.

TABLE 8

| APC3/starch | Turbidity | Reduction in | |
|---|---|---|---|
| weight ratio | (NTU) | turbidity, % | Absorbance |
| 12/88 | 26 | 74 | 0.096 |
| 17/83 | 17 | 83 | 0.078 |
| 25/75 | 2 | 98 | 0.052 |
| 36/64 | <1 | >99 | 0.052 |

### EXAMPLE 6

### Comparison of Cationic Starches in Solution of Different Botanical Origin

Solutions of cationic starches comprising 1.2% of nitrogen (expressed in dry/dry weight) are obtained from waxy corn, from amylose-rich corn, from proteinaceous pea and from potato.

Starch Solutions Used

“4”: Solution of cationic starch based on waxy corn, with Brookfield viscosity, according to test A, of 1240 mPa·s.

“5”: Solution of cationic starch based on amylose-rich corn, with Brookfield viscosity, according to test A, of 1520 mPa·s.

“6”: Solution of cationic starch based on proteinaceous pea, with Brookfield viscosity, according to test A, of 1700 mPa·s.

“7”: Solution of cationic starch based on potato, with Brookfield viscosity, according to test A, of 1260 mPa·s.

The various starch solutions are tested mixed with a solution of ferric chloride, according to a salt:starch weight ratio of 3:2. The mixture of coagulant is used at a dose of 10 mg/L. The test protocol is the same as in example 1 and the results obtained are presented in Table 9.

TABLE 9

| | Viscosity | | |
|---|---|---|---|
| | of the | Turbidity of | |
| | starch in | the | Reduction |
| | water at | supernatant | in |
| Starch | 10% | (NTU) | turbidity, % |
| 4 | 1240 | <1 | >99 |
| 5 | 1520 | <1 | >99 |
| 6 | 1700 | <1 | >99 |
| 7 | 1260 | <1 | >99 |

### EXAMPLE 7

### Test on Clarification Pilot Equipment

The purpose of this example is to test the composition of the invention in a pilot continuous system.

Description of the Equipment:

The water to be treated is river water taken from the Lys. It is withdrawn from a 500 L tank by pump and is directed to a flow controller. The flowmeter is calibrated from 200 L/h to 600 L/h, and at its outlet there are branch pipes for injection of the reagents. Injection of two reagents separately and at different flow rates is possible owing to two small pumps connected to flowmeters. The water and the mixture then arrive in the coagulation-flocculation tank, and a taper propeller provides the stirring required for mixing the reagents. The water must then provide an overflow before reaching a lamellar sedimentation tank equipped with lamellae inclined at 45°. Once the sedimentation tank is completely filled, the clarified water overflows at a weir and flows to a sink or it can be recovered for analyses.

After calibration of the equipment, a mixture composed of polymer A in solution and ferric chloride is injected into the stirred tank at a dosage of 20 mg/L of starch and of salt. The weight ratio of ferric chloride to cationic starch A varies as a function of the flow rates required. The results for turbidity of the water at outlet are given in Table 10.

These tests show the effectiveness of the method according to the invention in an installation similar to an industrial installation.

TABLE 10

| | | Average | | | Average |
|---|---|---|---|---|---|
| Starch/ | Time | turbidity | FeCl₃/starch | Time | turbidity |
| FeCl₃ ratio | (min) | (NTU) | ratio | (min) | (NTU) |
| 100/0 | 0 | 3.3 | 40/60 | 0 | 1.7 |
| | 5 | 2.7 | | 4 | 1.9 |
| | 10 | 2.4 | | 8 | 1.5 |
| | 15 | 2.6 | | 12 | 1.7 |
| | 20 | 2.8 | | 16 | 1.7 |
| | 25 | 2.9 | | 20 | 1.4 |
| | 30 | 2.7 | | 25 | 1.3 |
| | 35 | 3.0 | | 30 | 1.4 |
| | 40 | 3.0 | | 35 | 1.3 |
| | 45 | 3.1 | | 40 | 1.3 |
| | 50 | 2.9 | | 45 | 1.3 |
| | 55 | 2.9 | | 50 | 1.3 |
| | 60 | 2.9 | | 55 | 1.3 |
| 80/20 | 0 | 3.0 | | 60 | 1.3 |
| | 5 | 2.5 | 20/80 | 0 | 7.9 |
| | 10 | 2.3 | | 5 | 3.5 |
| | 15 | 2.3 | | 10 | 3.9 |
| | 20 | 2.3 | | 15 | 3.2 |
| | 25 | 2.3 | | 20 | 3.3 |
| | 30 | 2.2 | | 25 | 3.5 |
| | 35 | 2.3 | | 30 | 3.3 |
| | 40 | 2.2 | | 35 | 3.4 |
| | 45 | 2.2 | | 40 | 3.6 |
| | 50 | 2.1 | | 45 | 3.1 |
| | 55 | 2.2 | | 50 | 2.7 |
| | 60 | 2.1 | | 55 | 3.1 |
| 60/40 | 0 | 1.8 | | 60 | 3.3 |
| | 5 | 1.5 | 0/100 | 0 | 4.3 |
| | 10 | 1.4 | | 5 | 3.7 |
| | 15 | 1.4 | | 10 | 3.4 |
| | 20 | 1.5 | | 15 | 3.5 |
| | 25 | 1.4 | | 20 | 3.5 |
| | 30 | 1.4 | | 25 | 3.5 |
| | 35 | 1.5 | | 30 | 3.5 |
| | 40 | 1.4 | | 35 | 3.4 |
| | 45 | 1.4 | | 40 | 3.6 |
| | 50 | 1.4 | | 45 | 3.5 |
| | | | | 50 | 3.4 |
| | | | | 55 | 3.4 |
| | | | | 60 | 3.4 |

1. A method of potabilization of an aqueous solution having solids in suspension, containing a coagulation-flocculation step, characterized in that said step comprises:
a) a step of adding a liquid composition comprising a solubilized cationic starch to the aqueous solution to be treated;
b) a step of adding one or more metal salts selected from ferric salts and aluminum salts to the aqueous solution to be treated; steps a) and b) being carried out in any order and they can be effected separately, simultaneously or by means of a liquid composition comprising both the solubilized cationic starch and the metal salt, said steps a) and b) being followed by:
c) a step of stirring the aqueous solution containing these additives;
d) a step of separating the coagulated solids by decanting or flotation;
e) a step of recovering purified water;
said liquid composition comprising cationic starch having a viscosity, measured according to a test A, above 1000 mPa·s, this test A consisting of adjusting the dry matter of the liquid composition to 10% and then measuring the Brookfield viscosity of the resultant composition at 25° C.

2. The method as claimed in claim 1, characterized in that the viscosity of the liquid composition comprising cationic starch, measured according to test A, is between 1100 and 500000 mPa·s.

3. The method as claimed in claim 1, characterized in that the viscosity of the liquid composition comprising cationic starch, measured according to test A, is between 10000 and 100000 mPa·s.

4. The method as claimed in claim 1, characterized in that the time delay between steps a) and b) is less than 120 seconds.

5. The method as claimed in claim 1, characterized in that steps a) and b) are carried out simultaneously.

6. The method as claimed in claim 1, characterized in that the total amount of cationic starch and of metal salt in the aqueous solution ranges from 4 to 500 ppm, preferably from 5 to 10 ppm.

7. The method as claimed in claim 1, characterized in that the cationic starch/metal salt weight ratio ranges from 15/85 to 70/30, preferably from 25/75 to 45/55.

8. The method as claimed in claim 1, characterized in that the separation step d) is a decanting step.

9. The method as claimed in claim 1, characterized in that it comprises, after the coagulation-flocculation step, a step of filtration of the purified water.

10. The method as claimed in claim 1, characterized in that the turbidity of the purified water obtained at the end of step e) is less than or equal to 1.5 NTU, preferably below 1 NTU.

11. A liquid composition suitable for use in the method as claimed in claim 1, comprising a solubilized cationic starch and or more metal salts selected from ferric salts and aluminum salts, whose viscosity, measured according to test A, is above 1000 mPa·s.

12. The composition as claimed in claim 11, characterized in that the viscosity of the liquid composition comprising cationic starch, measured according to test A, is between 10000 and 100000 mPa·s.

13. The composition as claimed in claim 11, characterized in that the metal salt is an aluminum salt.

14. The composition as claimed in claim 11, characterized in that the cationic starch/metal salt weight ratio ranges from 15/85 to 70/30, preferably from 25/75 to 45/55.

15. The composition as claimed in claim 11, characterized in that it has a pH between 3 and 7.
